(19) United States
(12) Patent Application Publication
(10) Pub. No.: US 2024/0346467 A1
(43) Pub. Date: Oct. 17, 2024

(54) System and Method for Digital Currency Distribution and Transactions

(71) Applicant: CorCo Systems a.s., Praha 8 - Karlín (CZ)

(72) Inventor: Josef Rafaj, Prague 7 (CZ)

(21) Appl. No.: 18/677,705

(22) Filed: May 29, 2024

Related U.S. Application Data
(63) Continuation-in-part of application No. PCT/IB2022/055652, filed on Jun. 17, 2022.

(30) Foreign Application Priority Data
Nov. 29, 2021 (CZ) 2021-542

(51) Int. Cl. G06Q 20/06; G06Q 20/38

(52) U.S. Cl. CPC G06Q 20/065; G06Q 20/386

(57) ABSTRACT

This disclosure provides methods, components, devices, and systems for providing a type of digital currency acceptable at participating businesses, allowing customers to pay at least a portion of the goods using the digital currency. Some aspects, more specifically, relate to a method that allocates an amount of digital currency from issued funds to a registered consumer. The digital currency is accepted by at least one participating business. The method also distributes the amount of the digital currency to the registered consumer, including a transaction code, and receives a transaction notice from the participating business, including a portion of the digital currency associated with a transaction at the participating business and the transaction code. The method further validates the transaction notice, including the transaction code and the portion of the digital currency that is available to the registered consumer, and transmits a validation notice to the participating business.

### CROSS-REFERENCE TO RELATED APPLICATIONS

The present Application for Patent is a continuation-in-part of International Patent Application No. PCT/IB2022/055652, filed Jun. 17, 2022, and entitled “Economy Support Method and Device for Performing this Method,” which claims priority to Czechia Application No. 2021-542 filed Nov. 29, 2021, both of which are assigned to the assignee hereof and hereby expressly incorporated by reference herein.

### BACKGROUND

This disclosure relates generally to digital currency and, more specifically, to providing a type of digital currency acceptable at participating businesses, allowing customers to pay at least a portion of the goods or services using the digital currency.

A typical transaction between a customer and a business involves a customer selecting a product or server they are interested in purchasing. This product or service includes a price which is usually displayed on the product or communicated by the business. If the customer decides to purchase the product or service, the customer pays the business using acceptable forms of currency such as government-issued currency (e.g., US Dollar, Euro, British Pound, Japanese Yen), banknotes, debit or credit cards, cryptocurrency, and the like.

Businesses employ a variety of strategies tailored to their respective business model, product type, target customer base, and overall marketing goals, which provide discounts to attract customers to their business. These strategies include providing a percentage off, a dollar amount off, buy one, get one free, volume discounts, flash sales, seasonal and clearance sales, loyalty rewards, coupon codes, and the like. Coupon codes, for instance, can be promotional codes offered to customers to redeem at checkout for a discount. These can be distributed through email, mobile messages, advertisements, or social media.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for providing a type of digital currency acceptable at participating businesses, allowing customers to pay at least a portion of the goods using the digital currency. The method also includes allocating an amount of digital currency from issued funds to a registered consumer. The digital currency is accepted by at least one participating business. The method also includes distributing the amount of the digital currency to the registered consumer, including a transaction code. The method further includes receiving a transaction notice from the participating business, including a portion of the digital currency associated with a transaction at the participating business and the transaction code. The method also includes validating the transaction notice, including the transaction code and the portion of the digital currency available to the registered consumer, and transmitting a validation notice to the participating business.

In some examples, the transaction notice includes a password associated with the participating business and further includes verifying the password is valid and associated with the participating business.

In some examples, distributing the amount of the digital currency and the transaction code includes transmitting a text message to a phone number associated with the registered consumer, including the amount of the digital currency and the transaction code.

In some examples, the method further includes adjusting the amount of digital currency available to the registered consumer based on the portion of the digital currency used in the transaction, creating a new transaction code associated with an updated amount of the digital currency, and the registered consumer, and distributing the updated amount of the digital currency to the registered consumer including the new transaction code. In some examples, the amount of digital currency is stored in a registered consumer database and a participating business database.

In some examples, validating the transaction notice includes verifying the portion of the digital currency is available from the amount of the digital currency stored in the registered consumer database and verifying the portion of the digital currency is available from the amount of the digital currency stored in the participating business database.

In some examples, the method further includes recording the transaction in a database associated with the participating business, recording the transaction in a second database associated with the registered consumer, and adjusting the total amount of the issued funds in an issuer database, wherein the issuer database stores the issued funds associated with the digital currency.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The systems, methods, and devices of this disclosure each have several innovative aspects, no single one of which is solely responsible for the desirable attributes disclosed herein.

FIG. 1 illustrates a block diagram of an exemplary digital currency distribution environment, in accordance with embodiments of the present disclosure.

FIG. 2 illustrates a block diagram of an exemplary digital currency distribution system for providing digital currency to registered consumers and facilitating transactions of the digital currency at participating businesses, in accordance with embodiments of the present disclosure.

FIG. 3A illustrates a communication interface for text-based communication between a registered consumer and the digital currency distribution system, in accordance with embodiments of the present disclosure.

FIG. 3B illustrates a communication interface for text-based communication between a registered consumer and the digital currency distribution system, in accordance with embodiments of the present disclosure.

FIG. 4 illustrates a flowchart for providing digital currency to registered consumers and facilitating transactions of the digital currency at participating businesses, in accordance with embodiments of the present disclosure.

FIG. 5 illustrates a schematic diagram of an exemplary environment in which a digital currency distribution system can operate, in accordance with embodiments of the present disclosure.

FIG. 6 illustrates a block diagram of an exemplary computing device configured to operate a digital currency distribution system, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to providing a type of digital currency acceptable at participating businesses allowing customers to pay at least a portion of the goods using the digital currency. More specifically, this disclosure relates to providing an alternative form of payment at participating businesses or vendors by distributing a digital currency to customers who can then use at least a portion of the digital currency at those participating businesses or vendors. The following description is directed to some particular examples for the purpose of describing innovative aspects of this disclosure. However, a person having ordinary skill in the art will readily recognize that the teachings herein can be applied in a multitude of different ways.

### Overview

The economics behind consumer spending and how well businesses perform can include multiple factors such as supply and demand, price mechanisms, market structure, consumer spending, business investment, economic indicators, regulatory environment, technological advancements, globalization, and the like. Any one of these factors can greatly affect the profitability of a business.

At the core of most transactions is the basic economic principle of supply and demand. Businesses supply goods or services, and customers demand these. Prices generally adjust based on the amount of supply relative to demand. High demand and low supply typically lead to higher prices, while low demand and high supply may drive prices down. The price of goods and services is a critical element in transactions. It not only reflects the value that consumers place on the goods but also the cost to the business of providing them. Pricing strategies can vary widely, influenced by factors such as competition, production costs, and consumer perception of value.

The nature of the type of market the business is in also affects transactions. Markets can be competitive, with many buyers and sellers, or monopolistic, where few businesses control the majority of the supply. There are also oligopolies (a few businesses dominate) and perfectly competitive markets (many businesses offer similar products, and none can influence market prices significantly). Additionally, consumer spending plays a part in how well a business may perform. Consumer spending is driven by consumer income, confidence, and economic outlook. Economic conditions, personal financial situations, and expectations about the future can all affect how much consumers are willing to spend.

Other factors outside the control of a business can also affect how well a business performs. For instance, natural disasters or pandemics can severely impact businesses through various technical and operational challenges. These challenges include supply chain disruptions, damage to physical infrastructure, workforce availability, IT and communication failures, increased operational costs, regulatory and compliance challenges, business continuity planning failures, customer demand fluctuations, and the like.

Supply chain disruptions, for example, can interrupt supply chains by causing physical damage to transportation infrastructure, supplier facilities, or logistics hubs. This disruption can lead to delays or failures in receiving essential materials and products, impacting production and delivery schedules. Earthquakes, floods, hurricanes, and other natural disasters can also physically damage a business's facilities, machinery, and technology infrastructure. This may result in costly repairs and downtime, which can cripple operations and lead to lost revenue.

Governments and outside organizations can assist consumers and businesses during such events through various forms of help aimed at stabilizing the economy, preserving jobs, and helping businesses navigate through challenging periods. These forms include financial assistance (e.g., grants and direct aid, low-interest loans, tax relief), regulatory flexibility (e.g., relaxation of regulations, expedited services), employment support (e.g., wage subsidies and job retention schemes, training and reskilling programs), sector-specific support (e.g., targeted assistance, research and development incentives), trade and export support (e.g., export guarantees and insurance, assistance with market diversification), and the like. These measures are typically designed to be temporary, targeted, and scalable, depending on the severity of the event and the specific needs of the economy or the sectors most affected.

Limitations on third-party assistance remain, however, as these forms of assistance present several issues and challenges. These issues include lack of transparency when distributing funds, inefficiency in allocation, favoritism and inequity, dependency, economic distortion, complexity and accessibility, short-term focus, and the like. Inefficiency in allocation, for instance, can involve financial aid not reaching the targeted businesses that need it most urgently. Delays in processing or bureaucratic red tape can also hinder the timely distribution of funds.

Various aspects of the disclosure improve existing technologies, as well as others, by providing methods, components, and systems that support providing a type of digital currency acceptable at participating businesses, allowing customers to pay at least a portion of the goods using the digital currency. These aspects can aid in providing funds distributed to targeted and participating businesses in a transparent manner using a system of interconnected databases. A series of consumer, issuer, and business databases provide transparency between the consumer, business, and funds issuer. These databases allow for transparent allocation of resources (e.g., public funds, third-party funds) to consumers. The consumers can participate in the service by registering. Once registered, the consumer is issued a portion of the funds in the form of a digital currency. The digital currency can then be spent at participating businesses to pay for at least a portion of the goods or services offered by the business.

Particular aspects of the subject matter described in this disclosure can be implemented to realize one or more of the following potential advantages. The present disclosure aims to provide real-time and automated distribution of funds to consumers that are targeted to participating businesses or vendors by implementing mechanisms that ensure transparent allocation of funds from a governmental entity or third party. By providing mechanisms of fund distribution to consumers that are usable to specific businesses, consumers can decide how much and where to provide direct support through their purchases. This mechanism incentivizes businesses to provide the best possible product or service so that customers purchase their goods or services. Additionally, businesses may receive more funds than they may have received through traditional assistance programs as consumers may spend additional funds at the business when purchasing a good or service.

### Example Digital Currency Distribution Environment

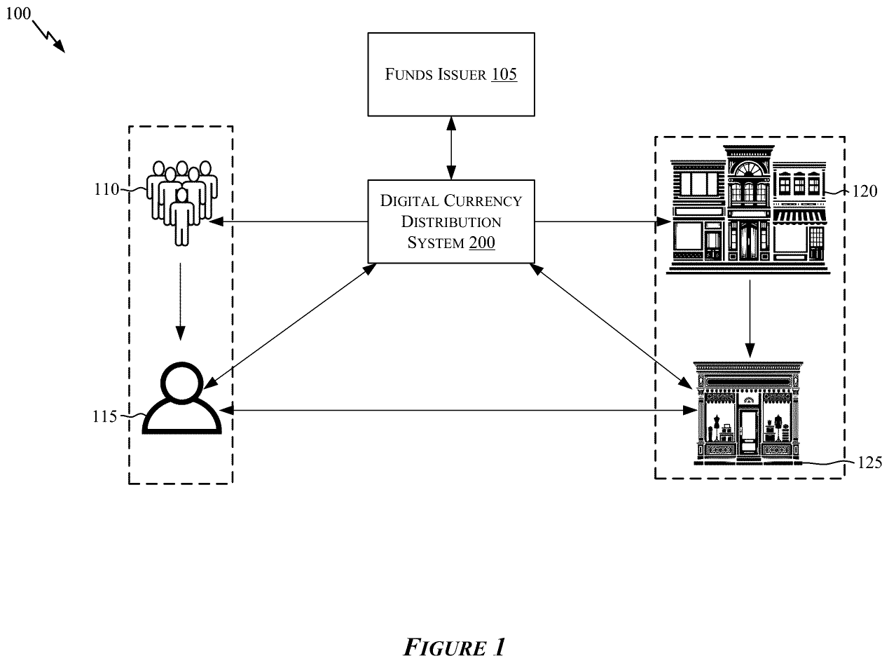

Referring now to FIG. 1, a block diagram of an example digital currency distribution environment 100 suitable for implementing embodiments of the disclosure is shown. The digital currency distribution environment 100 is an environment in which a digital currency distribution system 200 operates. The digital currency distribution environment 100 can be a city, state, region, metropolis, suburb, village, hamlet, rural area, municipality, township, borough, county, and the like. As shown, the digital currency distribution environment 100 includes a funds issuer 105, a group of consumers 110, an individual consumer 115 from the group of consumers 110, a group of businesses 120, and an individual business 125 from the group of businesses 120. These entities operate within the digital currency distribution environment 100 and utilize embodiments of the digital currency distribution system 200.

The funds issuer 105 is an entity providing funds to the digital currency distribution system 200. The funds issuer 105 can be a governmental entity or government agency, an international organization, a non-governmental organization, a foundation, an educational institution, a corporate giving program, a religious organization, a crowdfunding platform, and the like. The fund issuer 105 can provide the funds that can then be converted into a digital currency that can only be used at participating businesses.

In some implementations, the funds issuer 105 provides restrictions on the allocation and distribution of the digital currency. For instance, the funds issuer 105 may restrict the type of individuals eligible for digital currency distribution or may require individuals to submit an application with the digital currency distribution system 200. In another example, the funds issuer 105 may also restrict the type of businesses that can participate in receiving the digital currency from the registered consumers.

In some implementations, the funds issuer 105 retains the actual funds, and the digital currency distribution system 200 can request funds at a given time. For instance, once a transaction occurs between a registered consumer and a participating business, the business may request a conversion from digital currency to actual funds. Upon request, the digital currency distribution system 200 can request the converted funds once the transaction has been verified and approved. In some implementations, the funds issuer 105 distributes actual funds at an interval or periodically and can request a transaction history from the digital currency distribution system 200 in order to facilitate the conversion from digital currency to actual currency.

The group of consumers 110 can include individuals residing within the digital currency distribution environment 100 or individuals interested in purchasing goods or services from the group of businesses 120. In some implementations, the group of consumers 110 is selectively chosen based on predetermined criteria.

The group of businesses 120 includes businesses operating within the digital currency distribution environment 100 and participating in the embodiments described in the disclosure.

### Example Digital Currency Distribution System

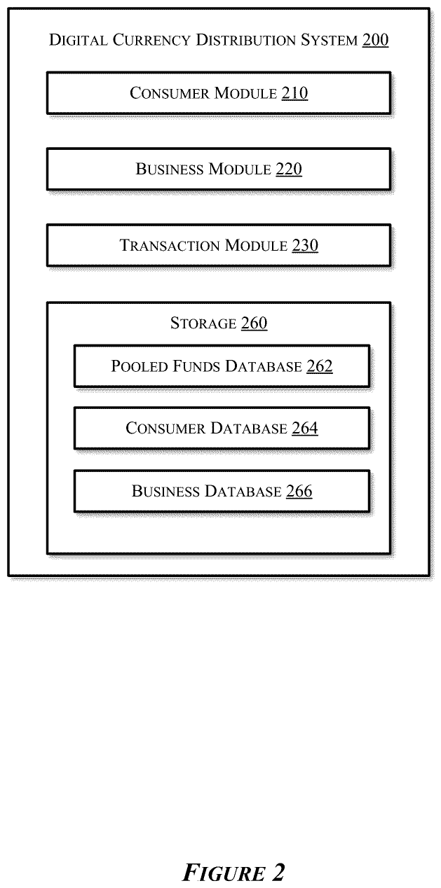

Referring now to FIG. 2, a block diagram of an example digital currency distribution system 200 suitable for use in implementing embodiments of the disclosure is shown. The digital currency distribution system 200 is configured to provide a type of digital currency acceptable at participating businesses allowing customers to pay at least a portion of the goods using the digital currency. The digital currency distribution system 200 can distribute allocated funds across a locality or region in the form of a digital currency to consumers. Once distributed, the digital currency distribution system 200 provides mechanisms that support consumers using the digital currency at participating businesses. The digital currency distribution system 200 first allocates an amount of digital currency from issued funds (e.g., funds provided by a governmental entity, third-party, etc.) to a registered consumer. Once allocated and distributed to the user, the digital currency distribution system 200 can then provide mechanisms that allow the user to use the digital currency at the participating business. Using the digital currency, consumers are provided with discounted goods or services, and businesses are provided with additional business revenue as the digital currency can be converted into regular currency by the participating business.

The digital currency distribution system 200 can be implemented as a standalone application or as part of another application or suite of applications. For example, the digital currency distribution system 200 can be implemented as part of a banking system or banking application, enabling the digital currency distribution to be a module of the banking system application.

The digital currency distribution system 200 includes a consumer module 210, a business module 220, a transaction module 230, and storage 260. The storage includes an issued funds database 262, a consumer database 264, and a business database 266.

The consumer module 210 is a component of the digital currency distribution system 200 configured to manage individuals registered to participate in the digital currency distribution. In some implementations, the consumer module 210 sets requirements needed for eligibility to participate in the digital currency distribution. The eligibility criteria can include income levels, residency, age or disability, employment status, and the like.

The consumer module 210 is further configured to register individuals with the digital currency distribution system 200. The registration process can include receiving documentation, forms, and applications. For instance, individuals applying for the digital currency distribution system 200 may need to submit various documents, such as tax returns, pay stubs, proof of residence, and identification.

The consumer module 210 is further configured to apply restrictions on the distributed digital currency. In some instances, the digital currency may only be used at participating businesses. In some cases, the individual may have certain restrictions on their respective digital currency based on their registration. For instance, some individuals may be restricted from using funds for education, healthcare, housing, groceries, and the like.

In some implementations, the consumer module 210 may require the registered consumers to re-certify their eligibility after spending their allocated digital currency. For example, a consumer is allocated 1,000 digital currency, or “COR”. Once that 1,000 COR is spent at participating businesses, the registered consumer may need to re-certify or re-register with the digital currency distribution system 200 to request additional digital currency.

The consumer module 210 is further configured to distribute an amount of digital currency to the registered consumer and provide the registered consumer with a transaction code. The transaction code can be a user-specific code that allows the consumer to access the digital currency by providing the transaction code to a participating business during a transaction. In some implementations, the consumer module 210 transmits a text message to the registered consumer, including the amount of digital currency allocated to them and their respective transaction code.

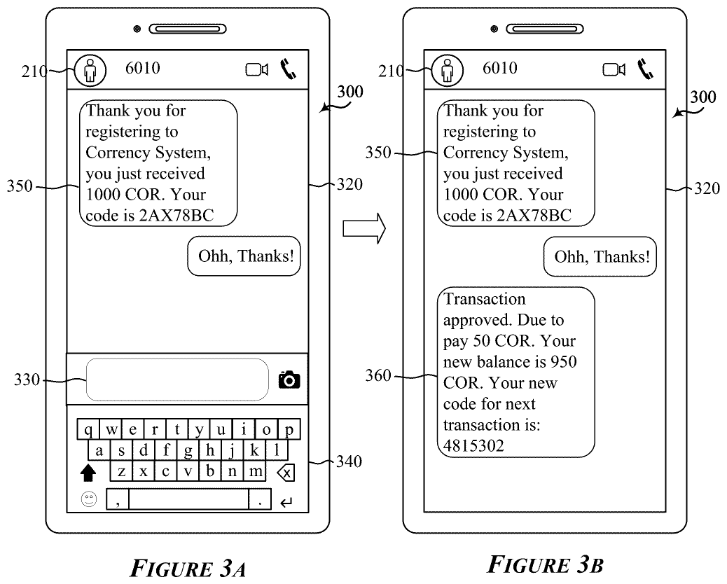

Referring briefly to FIGS. 3A-3B, an example text message from the consumer module 210 is shown. FIGS. 3A-3B illustrate an example communication interface 300 for text-based communication between a registered consumer and the digital currency distribution system 200, in accordance with embodiments of the present disclosure. As shown in FIG. 3A, and in this example, the communication interface 300 presents a visualization of a conversation between the registered consumer and the consumer module 210 in a dialog window 320. Additionally, the communication interface 300 includes an input field 330, a keyboard 340, and a text message 350. The communication interface 300 provides a chronological view of a conversation between the registered consumer and the consumer module 210.

As shown in FIG. 3A, the consumer module 210 has transmitted a text message 350 to the registered consumer, including an indication of the amount of allocated digital currency associated with the registered consumer and their respective transaction code that can be shown when using the digital currency.

As shown in FIG. 3B, the consumer module 210 has transmitted a second text message 360 to the registered consumer, including an indication of an updated amount of allocated digital currency associated with the registered consumer and an updated transaction code. This text message can occur when a registered consumer uses a portion of their allocated digital currency at a participating business. In some implementations, the registered consumer can transmit a text message to the consumer module 210 requesting a message including their current allocated digital currency and transaction code (not shown). In some implementations, the transaction code is continuously updated and transmitted to the registered consumer as an additional security feature.

Referring back to FIG. 2, the consumer module 210 is further configured to manage and update a consumer database 264, including a list of all registered consumers. In some implementations, the consumer database 264 includes each registered consumer, their restrictions, if any, the amount of digital currency distributed to the registered consumer, and the current transaction code provided to a consumer.

The business module 220 is a component of the digital currency distribution system 200 configured to manage businesses registered to participate in the digital currency distribution. In some implementations, the business module 210 sets the requirements needed for eligibility to participate in the digital currency distribution. The eligibility criteria can include business size, industry sector, location, compliance requirements, financial health and history, and the like. For example, the issued funds may be designated for a particular area. As such, the assistance might be targeted at businesses within the particular area. This area may be a particular region that is economically disadvantaged or has been affected by natural disasters.

The business module 220 is further configured to register participating businesses with the digital currency distribution system 200. The registration process can include receiving documentation, forms, and applications. For instance, participating businesses applying with digital currency distribution system 200 may need to submit various documents, such as financial statements, credit history, demonstrated need, and the like. Demonstrated need, for instance, may be needed to show that a particular business can demonstrate financial distress or a significant hardship from events like a pandemic or natural disaster.

The business module 220 is further configured to manage and update a business database 262, which includes a list of all participating businesses. In some implementations, the business database 262 includes each participating business, its restrictions, if any, and the amount of digital currency distributed to the registered consumers.

The business module 220 is further configured to provide participating businesses with a password that can be used when performing a transaction using the digital currency. For instance, the participating business can notate the amount of digital currency the registered consumer wishes to use with their transaction code and provide that information, including their password, to the digital currency distribution system 200. The password can then be used by the digital currency distribution system 200 to validate the authenticity of the business and avoid potential misuse of the system.

The transaction module 230 is a component of the digital currency distribution system 200 configured to facilitate transactions between registered consumers and participating businesses using the digital currency. The transaction module 230 can receive a transaction notice of a transaction occurring at a participating business and validate the transaction notice, including the amount of digital currency being used at the participating business and the transaction code provided to the business from the registered consumer. Upon validation, the transaction module 230 can transmit a validation notice to the participating business. In some instances, the validation notice includes a distribution of funds corresponding to the portion of digital currency used in the transaction by the registered consumer. For instance, 1 COR may correspond to 1 U.S. Dollar, or 1 COR may correspond to 10 U.S. Dollars. The conversion can range by any amount and can be determined by the funds issuer or the digital currency distribution system 200.

It is noted that FIG. 2 is intended to depict the major representative components of a digital currency distribution system 200. In some embodiments, however, individual components may have greater or lesser complexity than as represented in FIG. 2; components other than or in addition to those shown in FIG. 2 may be present, and the number, type, and configuration of such components may vary.

### Example Flow Diagram

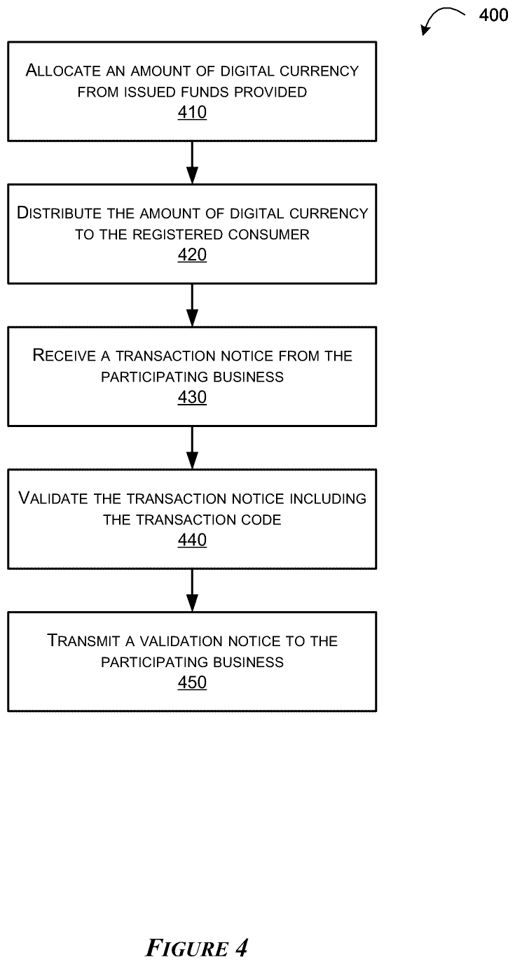

FIGS. 1-3B, the corresponding text, and the examples described provide a number of different systems that provide a type of digital currency acceptable at participating businesses, allowing customers to pay at least a portion of the goods using the digital currency. In addition to the foregoing, embodiments can also be described in terms of a flowchart comprising acts and steps to accomplish a particular result. For example, FIG. 4 illustrates a flowchart of an exemplary method in accordance with one or more embodiments. The method described in relation to FIG. 4 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 4, a flow diagram illustrating a method is provided. Each block of the method 400 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

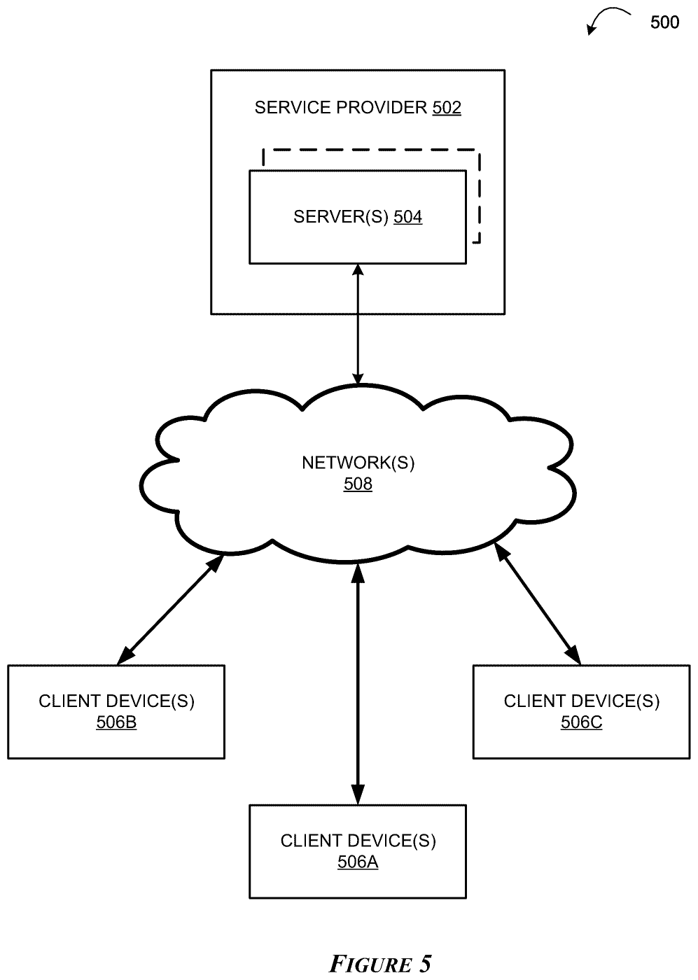

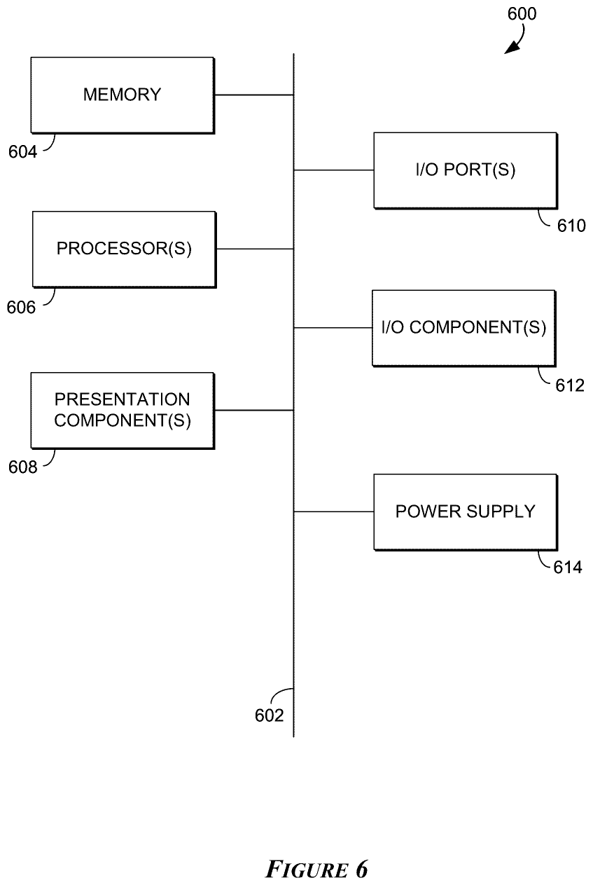

FIG. 4 shows a flowchart illustrating an example process 400 performable by or at a computing device that supports providing a type of digital currency acceptable at participating businesses allowing customers to pay at least a portion of the goods using the digital currency. For example, the process 400 may be performed by a computing device, such as the wireless computing device 600 described with reference to FIG. 6. In some examples, the process 400 may be performed within a computing environment such as the computing environment 500 described with reference to FIG. 5.

In some examples, the computing device is configured to perform the process 400 described with reference to FIG. 4. At block 410, the computing device allocates an amount of digital currency to a registered consumer. The digital currency can be a converted currency that is only accepted at participating businesses. An issuer can provide actual funds to the digital currency distribution system, which can then be redeemed by the participating businesses once a transaction has occurred. The registered consumer can be an individual who participates in the program provided by the digital currency distribution system.

At block 420, the computing device distributes an amount of the digital currency allocated to the registered consumer. The allocated amount can be a portion of the total amount of available digital currency that can be defined by the issuer. For instance, an issuer may dictate that each registered user should be allocated a percentage of the fund or a specific amount of digital currency once they register. The total number of registered users can depend on the amount of funds offered by the issuer. A transaction code can also be included in the distribution of digital currency to the registered consumer. As described, the transaction code can validate the registered consumer when making purchases using the digital currency.

In some implementations, the computing device transmits a text message to the registered consumer, including an indication of their allocated digital currency and their respective transaction code, which can be used when making purchases with the digital currency.

At block 430, the computing device receives a transaction notice from a participating business. The transaction notice can include the amount of digital currency being used in the transaction as well as the transaction code associated with the registered consumer.

At block 440, the computing device validates the transaction notice received from the participating business. Validating the transaction notice can include verifying the portion of the digital currency available from the amount of the digital currency stored in a consumer database and verifying that the transaction code corresponds to the transaction code stored in the consumer database.

In some implementations, the transaction notice includes a password associated with the participating business. The computing device can verify that the password corresponds with the password stored in the business database and is associated with the participating business.

At block 450, the computing device transmits a validation notice to the participating business upon verification of the transaction notice. In some implementations, the validation notice provides notice to the participating business that the transaction is approved and that the digital currency has been transmitted from the registered consumer to the participating business. In some implementations, the computing device automatically converts the digital currency used in the transaction to corresponding funds provided by an issuer.

In some implementations, the computing device adjusts the amount of digital currency available to the registered consumer based on the portion of the digital currency used in the transaction. This can take the form of a deduction of total digital currency by the amount of digital currency used in the transaction. The computing device can also create a new transaction code associated with an updated amount of the digital currency and the registered consumer and distribute the updated amount of the digital currency to the registered consumer, including the new transaction code.

In some implementations, the computing device records the transaction in a database associated with the participating business. The recording can include updating the amount of digital currency awarded to the participating business from the transaction. That digital currency can then be converted into funds provided by the issuer. The computing device can also record the transaction in a second database associated with the registered consumer, where the digital currency amount is updated to reflect a deduction in digital currency and an updated transaction code.

### Example Computing Environment

FIG. 5 illustrates a schematic diagram of an exemplary computing environment 500 in which the digital currency distribution system 200 can operate in accordance with one or more embodiments of the present disclosure. In one or more embodiments, the computing environment 500 includes a service provider 502, which may include one or more servers 504 connected to a plurality of client devices 506A-506C via one or more networks 508. The client devices 506A-506C, the one or more networks 508, the service provider 502, and the one or more servers 504 may communicate with each other or other components using any communication platforms and technologies suitable for transporting data and/or communication signals, including any known communication technologies, devices, media, and protocols supportive of remote data communications, examples of which will be described in more detail below with respect to FIG. 6.

Although FIG. 5 illustrates a particular arrangement of the client devices 506A-506C, the one or more networks 508, the service provider 502, and the one or more servers 504, various additional arrangements are possible. For example, the client devices 506A-506C may directly communicate with the one or more servers 504, bypassing the network 508. Or alternatively, the client devices 506A-506C may directly communicate with each other. The service provider 502 may be a public cloud service provider which owns and operates its own infrastructure in one or more data centers and provides this infrastructure to customers and end users on demand to host applications on the one or more servers 504. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 504 may similarly include one or more hardware servers, each with its own computing resources, which are divided among applications hosted by the one or more servers for use by members of the organization or their customers.

Similarly, although the computing environment 500 of FIG. 5 is depicted as having various components, the computing environment 500 may have additional or alternative components. For example, the environment 500 can be implemented on a single computing device with the digital currency distribution system 200. In particular, the digital currency distribution system 200 may be implemented in whole or in part on the client device 506A.

As illustrated in FIG. 5, the environment 500 may include client devices 506A-506C. The client devices 506A-506C may comprise any computing device. For example, client devices 506A-506C may comprise one or more personal computers, laptop computers, mobile devices, mobile phones, tablets, special purpose computers, or other computing devices, including computing devices described below with regard to FIG. 6. Although three client devices are shown in FIG. 5, it will be appreciated that client devices 506A-506C may comprise any number of client devices (greater or smaller than shown).

Moreover, as illustrated in FIG. 5, the client devices 506A-506C and the one or more servers 504 may communicate via one or more networks 508. The one or more networks 508 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 508 may be any suitable network over which the client devices 506A-506N may access service provider 502 and server 504, or vice versa.

In addition, the environment 500 may also include one or more servers 504. The one or more servers 504 may generate, store, receive, and transmit any type of data, input data, or other information. For example, a server 504 may receive data from a client device, such as the client device 506A, and send the data to another client device, such as the client device 502B and/or 502C. The server 504 can also transmit electronic messages between one or more users of the environment 500. In one example embodiment, the server 504 is a data server. The server 504 can also comprise a communication server or a web-hosting server. Additional details regarding the server 504 will be discussed below with respect to FIG. 6.

As mentioned, in one or more embodiments, the one or more servers 504 can include or implement at least a portion of the digital currency distribution system 200 and can comprise an application running on the one or more servers 504, or a portion of the digital currency distribution system 200 can be downloaded from the one or more servers 504. For example, the digital currency distribution system 200 can include a web hosting application that allows the client devices 506A-506C to interact with content hosted at the one or more servers 504. To illustrate, in one or more embodiments of the environment 500, one or more client devices 506A-506C can access a webpage supported by the one or more servers 504. In particular, the client device 506A can run a web application (e.g., a web browser) to allow a user to access, view, and/or interact with a webpage or website hosted at the one or more servers 504.

Upon the client device 506A accessing a webpage or other web application hosted at the one or more servers 504, in one or more embodiments, the one or more servers 504 can provide access to data associated with a digital currency distribution and transaction operation stored at the one or more servers 504. Moreover, the client device 506A can receive a request (i.e., via user input) to perform a digital currency transaction and provide the request to the one or more servers 504. Upon receiving the request, the one or more servers 504 can automatically perform the methods and processes described above.

As just described, the digital currency distribution system 200 may be implemented in whole, or in part, by the individual elements 502-508 of the computing environment 500. It will be appreciated that although certain components of the digital currency distribution system 200 are described in the previous examples with regard to particular elements of the computing environment 500, various alternative implementations are possible. For instance, in one or more embodiments, the digital currency distribution system 200 is implemented on any of the client devices 506A-C. Similarly, in one or more embodiments, the digital currency distribution system 200 can be implemented on the one or more servers 504. Moreover, different components and functions of digital currency distribution system 200 may be implemented separately among client devices 506A-506C, the one or more servers 504, and the network 508.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Operating Environment

Having described an overview of embodiments of the present technology, an example operating environment in which embodiments of the present technology may be implemented is described in order to provide a general context for various aspects of the present technology. Referring now to FIG. 6, in particular, an exemplary operating environment for implementing embodiments of the present technology is shown and designated generally as computing device 600. Computing device 600 is but one example of a suitable computing environment and is not intended to suggest any limitation as to the scope of use or functionality of the technology. Neither should computing device 600 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 602 that directly or indirectly couples the following devices: memory 604, one or more processors 606, one or more presentation components 608, input/output ports 610, input/output components 612, and illustrative power supply 614. Bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 6 merely illustrates an example computing device that can be used in connection with one or more embodiments of the present technology. A distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 604 includes computer storage media in the form of volatile or nonvolatile memory. The memory may be removable, non-removable, or a combination thereof. Examples of hardware devices include solid-state memory, hard drives, optical-disc drives, etc. Computing device 600 includes one or more processors that read data from various entities, such as memory 604 or I/O components 612. Presentation component(s) 608 presents data indications to a user or other device. Examples of presentation components include a display device, speaker, printing component, vibrating component, etc.

I/O ports 610 allow computing device 600 to be logically coupled to other devices, including I/O components 612, some of which may be built in. Illustrative components include a microphone, joystick, game pad, satellite dish, scanner, printer, wireless device, sensors, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.

Clause 1. A method of digital currency distribution and transaction support, the method including allocating an amount of digital currency converted from issued funds to a registered consumer, wherein the digital currency is accepted at least one participating business, distributing the amount of the digital currency to the registered consumer including a transaction code associated with the digital currency and the registered consumer, receiving a transaction notice from the participating business including a portion of the digital currency associated with a transaction at the participating business and the transaction code associated with the registered consumer, validating the transaction notice including the transaction code and the portion of the digital currency is available to the registered consumer, and transmitting a validation notice to the participating business including a distribution of funds corresponding to the portion of the digital currency. Thus, the illustrative embodiment provides technological improvements over conventional techniques by implementing a digital currency distribution system that performs more efficient funds distribution for a funds issuer that can define which consumers are eligible and which participating are eligible. The funds can then be used by the registered consumers as they see at the participating businesses.

Clause 2. The method of clause 1, where the transaction notice includes a password associated with the participating business further comprising verifying the password is valid and associated with the participating business.

Clause 3. The method of clause 1-2, where distributing the amount of the digital currency and the transaction code includes transmitting a text message to a phone number associated with the registered consumer including the amount of the digital currency and the transaction code.

Clause 4. The method of clause 1-3, further including adjusting the amount of digital currency available to the registered consumer based on the portion of the digital currency used in the transaction, creating a new transaction code associated with an updated amount of the digital currency and the registered consumer, and distributing the updated amount of the digital currency to the registered consumer including the new transaction code.

Clause 5. The method of clause 1-4, where the amount of digital currency is stored in a consumer database and a business database.

Clause 6. The method of clause 1-5, where validating the transaction notice includes verifying the portion of the digital currency is available from the amount of the digital currency stored in the registered consumer database, and verifying the transaction code corresponds to the transaction code stored in the consumer database.

Clause 7. The method of clause 1-6, further including recording the transaction in a database associated with participating business, and recording the transaction in a second database associated with the registered consumer.

Clause 8. The method of clause 1-7, further including adjusting a total amount of the issued funds in an issuer database, wherein the issuer database stores the issued funds associated with the digital currency.

Clause 9. A system for digital currency distribution and transaction support, the system including one or more memories that store processor-executable code, and one or more processors coupled with the one or more memories and individually or collectively configured to, in association with executing the code, cause the system to allocate a an amount of digital currency from issued funds to a registered consumer, where the digital currency is accepted at least one participating business, distribute the amount of the digital currency to the registered consumer including a transaction code associated with the digital currency and the registered consumer, receive a transaction notice from the participating business including a portion of the digital currency associated with a transaction at the participating business and the transaction code associated with the registered consumer, validate the transaction notice, wherein the transaction code is verified and the portion of the digital currency is available to the registered consumer, and transmit a validation notice to the participating business including a distribution of funds corresponding to the portion of the digital currency.

Clause 10 The system of clause 9, where the transaction notice includes a password associated with the participating business further comprising verifying the password is valid and associated with the participating business.

Clause 11. The system of clause 9-10, where distributing the amount of the digital currency and the transaction code includes transmitting a text message to a phone number associated with the registered consumer including the amount of the digital currency and the transaction code.

Clause 12. The system of clause 9-11, where the code further causes the system to adjust the amount of digital currency available to the registered consumer based on the portion of the digital currency used in the transaction, create a new transaction code associated with an updated amount of the digital currency and the registered consumer, and distribute the updated amount of the digital currency to the registered consumer including the new transaction code.

Clause 13. The system of clause 9-12, where the amount of digital currency is stored in a registered consumer database and a participating business database.

Clause 14. The system of clause 9-13, where validating the transaction notice causes the system to verify the portion of the digital currency is available from the amount of the digital currency stored in the registered consumer database, and verify the portion of the digital currency is available from the amount of the digital currency stored in the participating business database.

Clause 15. The system of clause 9-14, where the code further causes the system to record the transaction in a database associated with participating business, and record the transaction in a second database associated with the registered consumer.

Clause 16. The system of clause 9-15, where the code further causes the system to adjust a total amount of the issued funds in an issuer database, wherein the issuer database stores the issued funds associated with the digital currency.

Clause 17. A non-transitory computer readable storage medium including instructions stored thereon which, when executed by a processor, cause the processor to allocate a an amount of digital currency from issued funds to a registered consumer, wherein the digital currency is accepted at least one participating business, distribute the amount of the digital currency to the registered consumer including a transaction code associated with the digital currency and the registered consumer, receive a transaction notice from the participating business including a portion of the digital currency associated with a transaction at the participating business and the transaction code associated with the registered consumer, validate the transaction notice, wherein the transaction code is verified and the portion of the digital currency is available to the registered consumer, and transmit a validation notice to the participating business including a distribution of funds corresponding to the portion of the digital currency.

Clause 18. The computer readable storage medium of clause 17, where the transaction notice includes a password associated with the participating business further comprising verifying the password is valid and associated with the participating business.

Clause 19. The computer readable storage medium of clause 17-18, where distributing the amount of the digital currency and the transaction code includes transmitting a text message to a phone number associated with the registered consumer including the amount of the digital currency and the transaction code.

Clause 20. The computer readable storage medium of claim 17-19, where the code further causes the processor to adjust the amount of digital currency available to the registered consumer based on the portion of the digital currency used in the transaction, create a new transaction code associated with an updated amount of the digital currency and the registered consumer, and distribute the updated amount of the digital currency to the registered consumer including the new transaction code.

What is claimed is:

1. A method of digital currency distribution and transaction support, the method comprising:
allocating an amount of digital currency converted from issued funds to a registered consumer, wherein the digital currency is accepted at a participating business;
distributing the amount of the digital currency to the registered consumer including a transaction code associated with the digital currency and the registered consumer;
receiving a transaction notice from the participating business including a portion of the digital currency associated with a transaction at the participating business and the transaction code associated with the registered consumer;
validating the transaction notice including the transaction code and the portion of the digital currency available to the registered consumer; and
transmitting a validation notice to the participating business including a distribution of funds corresponding to the portion of the digital currency.

2. The method of claim 1, wherein the transaction notice includes a password associated with the participating business further comprising verifying the password is valid and associated with the participating business.

3. The method of claim 1, wherein distributing the amount of the digital currency and the transaction code includes transmitting a text message to a phone number associated with the registered consumer including the amount of the digital currency and the transaction code.

4. The method of claim 1, further comprising:
adjusting the amount of the digital currency available to the registered consumer based on the portion of the digital currency used in the transaction;
creating a new transaction code associated with an updated amount of the digital currency and the registered consumer; and
distributing the updated amount of the digital currency to the registered consumer including the new transaction code.

5. The method of claim 1, wherein the amount of the digital currency is stored in a consumer database and a business database.

6. The method of claim 5, wherein validating the transaction notice includes:
verifying the portion of the digital currency is available from the amount of the digital currency stored in the consumer database; and
verifying the transaction code corresponds to the transaction code stored in the consumer database.

7. The method of claim 1, further comprising:
recording the transaction in a database associated with the participating business; and
recording the transaction in a second database associated with the registered consumer.

8. The method of claim 1, further comprising:
adjusting a total amount of the issued funds in an issuer database, wherein the issuer database stores the issued funds associated with the digital currency.

9. A system for digital currency distribution and transaction support, the system comprising:
one or more memories that store processor-executable code; and
one or more processors coupled with the one or more memories and individually or collectively configured to, in association with executing the code, cause the system to:
allocate an amount of digital currency from issued funds to a registered consumer, wherein the digital currency is accepted at a participating business;
distribute the amount of the digital currency to the registered consumer including a transaction code associated with the digital currency and the registered consumer;
receive a transaction notice from the participating business including a portion of the digital currency associated with a transaction at the participating business and the transaction code associated with the registered consumer;
validate the transaction notice, wherein the transaction code is verified and the portion of the digital currency is available to the registered consumer; and
transmit a validation notice to the participating business including a distribution of funds corresponding to the portion of the digital currency.

10. The system of claim 9, wherein the transaction notice includes a password associated with the participating business further comprising verifying the password is valid and associated with the participating business.

11. The system of claim 9, wherein distributing the amount of the digital currency and the transaction code includes transmitting a text message to a phone number associated with the registered consumer including the amount of the digital currency and the transaction code.

12. The system of claim 9, wherein the code further causes the system to:
adjust the amount of the digital currency available to the registered consumer based on the portion of the digital currency used in the transaction;
create a new transaction code associated with an updated amount of the digital currency and the registered consumer; and
distribute the updated amount of the digital currency to the registered consumer including the new transaction code.

13. The system of claim 9, wherein the amount of the digital currency is stored in a consumer database and a business database.

14. The system of claim 13, wherein validating the transaction notice causes the system to:
verify the portion of the digital currency is available from the amount of the digital currency stored in the consumer database; and
verify the portion of the digital currency is available from the amount of the digital currency stored in the business database.

15. The system of claim 9, wherein the code further causes the system to:
record the transaction in a database associated with the participating business; and
record the transaction in a second database associated with the registered consumer.

16. The system of claim 9, wherein the code further causes the system to:
adjust a total amount of the issued funds in an issuer database, wherein the issuer database stores the issued funds associated with the digital currency.

17. A non-transitory computer readable storage medium including instructions stored thereon which, when executed by a processor, cause the processor to:
allocate an amount of digital currency from issued funds to a registered consumer, wherein the digital currency is accepted at a participating business;
distribute the amount of the digital currency to the registered consumer including a transaction code associated with the digital currency and the registered consumer;
receive a transaction notice from the participating business including a portion of the digital currency associated with a transaction at the participating business and the transaction code associated with the registered consumer;
validate the transaction notice, wherein the transaction code is verified and the portion of the digital currency is available to the registered consumer; and
transmit a validation notice to the participating business including a distribution of funds corresponding to the portion of the digital currency.

18. The computer readable storage medium of claim 17, wherein the transaction notice includes a password associated with the participating business further comprising verifying the password is valid and associated with the participating business.

19. The computer readable storage medium of claim 17, wherein distributing the amount of the digital currency and the transaction code includes transmitting a text message to a phone number associated with the registered consumer including the amount of the digital currency and the transaction code.

20. The computer readable storage medium of claim 17, wherein the code further causes the processor to:
adjust the amount of the digital currency available to the registered consumer based on the portion of the digital currency used in the transaction;
create a new transaction code associated with an updated amount of the digital currency and the registered consumer; and
distribute the updated amount of the digital currency to the registered consumer including the new transaction code.
